(19) United States
(12) Patent Application Publication
(10) Pub. No.: US 2020/0173569 A1
(43) Pub. Date: Jun. 4, 2020

(54) INTEGRATED FLOW CHECK FOR WATER/COOLANT VALVES

(71) Applicants: Michael J. Koch, Roselle, IL (US); Thomas J. Davern, St. Charles, IL (US); James E. Pearson, Downers Grove, IL (US)

(72) Inventors: Michael J. Koch, Roselle, IL (US); Thomas J. Davern, St. Charles, IL (US); James E. Pearson, Downers Grove, IL (US)

(73) Assignee: Robertshaw Controls Company, Itasca, IL (US)

(21) Appl. No.: 16/684,215

(22) Filed: Nov. 14, 2019

Related U.S. Application Data
(60) Provisional application No. 62/774,654, filed on Dec. 3, 2018.

(51) Int. Cl. F16K 15/18; F16K 11/10

(52) U.S. Cl. CPC F16K 15/188; F16K 11/10

(57) ABSTRACT

A multi-port valve is provided. The multi-port valve includes a housing which defines an internal cavity. The housing further includes a plurality of ports. Each of the plurality of ports is in communication with the internal cavity. A valve member is rotatably disposed within the internal cavity. A seal member is also provided between the internal cavity and at least one of the ports. A check valve assembly is also provided in fluid communication with at least one of the ports to provide an additional checked flow therefrom or a checked flow therethrough. Temperature, pressure, and/or flow sensors may also be provided.

### CROSS-REFERENCE TO RELATED PATENT APPLICATIONS

This patent application claims the benefit of U.S. Provisional Patent Application No. 62/774,654, filed Dec. 3, 2018, the entire teachings and disclosure of which are incorporated herein by reference thereto.

### FIELD OF THE INVENTION

This invention generally relates to valves, and more particularly to multi-port valves and check valves.

### BACKGROUND OF THE INVENTION

Multi-port valve are used in a variety of industries and applications. Such valves include one or more inlet ports and on or more outlet ports. A valve member disposed within a housing of the valve is responsible for governing the flow between the various ports. A portion of the valve member, e.g. a valve stem, protrudes from the housing and is acted upon by an actuator attached to the multi-port valve. As result, the actuator governs the position of the valve member within the housing, which in turn governs the flow between the various ports. Such multi-port valves advantageously provide a single flow device which can effectively replace multiple flow devices which only employ a single inlet and a single outlet.

One such multiport valve is described in U.S. Pat. No. 7,506,664, entitled AUTOMOTIVE COOLANT CONTROL VALVE, filed Apr. 27, 2006, and issued Mar. 24, 2009, the teachings and disclosure of which are hereby incorporated in their entireties by reference thereto.

However, some multi-port valves are not without their own drawbacks. For example, the overall complexity of the valve increases as the number of ports increases. This can lead to relatively high part count assemblies. Further, this complexity in construction also results in a more complex manufacturing process for making valve. Indeed, the multiple ports are associated with multiple inlets and outlets of the valve which must be welded onto a housing. Further the desired fitting for each inlet and outlet must also be welded on to its respective inlet or outlet.

Such welded up assemblies increase the number of potential leak paths of the valve. Further, to achieve such welds, special machining steps are often needed at the inlets and outlets as well as the housing to ensure there is a tight fit between these components for subsequent welding.

Furthermore, a number of individual seals are required to effectively seal the various ports of the multi-port valve off from one another. These multiple seals also lead to an increase in overall cost and complexity of the multi-port valve.

One such multiport valve that advantageously provides a solution to the above issues and others is described in co-pending application Ser. No. 15/945,173, entitled MULTI-PORT VALVE, filed Apr. 4, 2018, and claiming priority to provisional application No. 62/483,167, filed on Apr. 7, 2017, the teachings and disclosure of which are hereby incorporated in their entireties by reference thereto.

Still further, current multi-port valves, while providing flow control between selected ports, do not provide directional flow control and instead rely on differential pressure at each port to control direction of flow. However, in many applications, it may be necessary or desirable to provide a check on the flow between ports coupled via the valving member or between ports during transitory coupling as the valving member is transitioning between ports.

Accordingly, there is a need in the art for a multi-port valve with a reduced overall complexity and flow control. Embodiments of the invention provide such a multi-port valves. These and other advantages of the invention, as well as additional inventive features, will be apparent from the description of the invention provided herein.

### BRIEF SUMMARY OF THE INVENTION

In one aspect, embodiments of the invention provide a multi-port valve having a reduced part count and a reduced cost relative to prior designs. An embodiment of such a multi-port valve includes a housing. The housing defines an internal cavity. The housing further includes a plurality of ports. Each of the plurality of ports is in communication with the internal cavity. This embodiment also includes a shell body (also referred to herein as a valve member) rotatably disposed within the internal cavity. A seal member is also provided which has a plurality of openings and surrounds the shell body such that it circumscribes the shell body within the internal cavity.

In certain embodiments, each opening of the plurality of openings of the seal member is associated with one of the plurality of ports such that each of the plurality of ports are sealed from one another along the outer periphery of the seal member.

In certain embodiments, the plurality of ports includes a first port and a second port. The first port and second port of the plurality of ports are arranged relative to one another such that they are one of angularly spaced apart from one another in an angular direction and situated at a same axial height relative to a longitudinal axis of the housing., or in at least a partially angularly overlapped arrangement relative to one another in the angular direction and are axially spaced from one another relative to the longitudinal axis.

In certain embodiments, the seal member seals outwardly in a radial direction against an interior surface of the housing. In other embodiments, the seal member includes a plurality of seal ribs which seal against the shell body. The seal member may be one of a continuous piece of elastomeric material, or comprises a rigid core with a plurality of elastomeric seals attached thereto.

In certain embodiments, the valve also includes a plurality of port bodies, respectively received in the plurality of ports such that one port body of the plurality of port bodies is received in one port of the plurality of ports.

In certain embodiments, the seal member comprises a plurality of seal segments. One of the seal segments sealingly engages a first and a second port body of the plurality of port bodies.

In certain other embodiments, the valve includes individual check valves and individual flow control valves. Such check valve members are included in one embodiment at the port, and in other embodiments in ports within the port bodies of other ports, or both. Such embodiments allow flow control checking to ensure correct fluid flow therethrough during quiescent and transitional operation of the valve, as well as proper sequencing of flow, particularly in mixing and separating flow applications.

In yet other embodiments, the valve includes temperature monitoring, flow rate monitoring and pressure monitoring through use and placement or appropriate temperature, flow, and/or pressure sensors. Such sensing occurs in some embodiments for each, and in other embodiments for multiple of the above ports and/or port bodies.

In another aspect, the invention provides a multi-port valve that includes an integrated check valve providing on demand flow checking. An embodiment of such a multi-port valve according to this aspect includes a housing defining an internal cavity and having a plurality of ports in communication with the internal cavity. A valve member is rotatably disposed within the internal cavity. At least one seal member is sealingly positioned between the valve member and at least one of the plurality of ports. A check valve assembly is in fluid communication with at least one of the plurality of ports to provide at least one of an additional checked flow therefrom or a checked flow therethrough.

In certain embodiments according to this aspect, the plurality of ports includes a first port, a second port, and a third port arranged relative to one another such that they are angularly spaced apart from one another in an angular direction and situated at a same axial height relative to a longitudinal axis of the housing.

In certain embodiments according to this aspect, a plurality of port bodies are respectively received in the plurality of ports such that one port body of the plurality of port bodies is received in one port of the plurality of ports. The at least one seal member may include a plurality of seal members, respectively sealing against one port body of the plurality of port bodies. Each seal member of the plurality of seal members respectively axially overlaps an end portion of each port body such that a radial seal is formed between each seal member and each respective port body. Each seal member of the plurality of seal members axially seals against the valve member.

In embodiments according to this aspect, one port body of the plurality of port bodies includes a check housing extending along an axis transverse to a flow axis of the port body. The check housing contains the check valve assembly. A check port body is mounted to the check housing and constrains the check valve assembly within the check housing.

In yet another aspect, the invention provides a multi-port valve that allows for flow sequencing based on flow control through the valve. An embodiment of such a multi-port valve includes a housing defining an internal cavity and having a plurality of ports in communication with the internal cavity. A plurality of port bodies are respectively received in the plurality of ports. A valve member is rotatably disposed within the internal cavity. At least one seal member is sealingly positioned between the valve member and at least one of the plurality of ports. A check valve assembly is mounted to one of the plurality of port bodies and has a closed position wherein fluid flow through the check valve assembly from the port body the check valve assembly is mounted to is prevented, and an open position wherein fluid flow through the check valve assembly from the port body the check valve assembly is mounted to is allowed. The check valve assembly is configured to transition from the closed position to the open position upon a transitioning of the valve member such that flow is one of reduced or prevented through another one of the port bodies of the plurality of port bodies.

In embodiments according to this aspect, the plurality of ports includes a first port, a second port, and a third port arranged relative to one another such that they are angularly spaced apart from one another in an angular direction and situated at a same axial height relative to a longitudinal axis of the housing.

In certain embodiments according to this aspect, the at least one seal member includes a plurality of seal members, respectively sealing against one port body of the plurality of port bodies. Each seal member of the plurality of seal members respectively axially overlaps an end portion of each port body such that a radial seal is formed between each seal member and each respective port body. Each seal member of the plurality of seal members axially seals against the valve member.

In certain embodiments according to this aspect, one port body of the plurality of port bodies includes a check housing extending along axis transverse to a flow axis of the port body. The check housing contains the check valve assembly. A check port body is mounted to the check housing and constrains the check valve assembly within the check housing.

In yet another aspect, the invention provides a multi-port valve that includes a port body with an integrated check valve assembly. An embodiment according to this aspect includes a housing defining an internal cavity and having a plurality of ports in communication with the internal cavity. A plurality of port bodies are respectively received in the plurality of ports. One port body of the plurality of port bodies includes a check housing extending along an axis transverse to a flow axis of the port body. A valve member is rotatably disposed within the internal cavity. At least one seal member is sealingly positioned between the valve member and at least one of the plurality of ports. A check valve assembly is mounted within the check housing.

In certain embodiments according to this aspect, the at least one seal member includes a plurality of seal members, respectively sealing against one port body of the plurality of port bodies. Each seal member of the plurality of seal members respectively axially overlaps an end portion of each port body such that a radial seal is formed between each seal member and each respective port body.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of one embodiment of a multi-port valve according to the teachings of the present invention; and

FIG. 2 is a perspective cross-sectional view of the embodiment of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the figures, as will be understood from the following, embodiments of a multi-port valve assembly and its associated multi-port valve having integrated flow checking and sequencing are described herein. The multi-port valve advantageously overcomes existing problems in the art by providing flow check between ports and/or within port bodies during both quiescent and transient valve operation, and to provide proper sequencing of flows between ports.

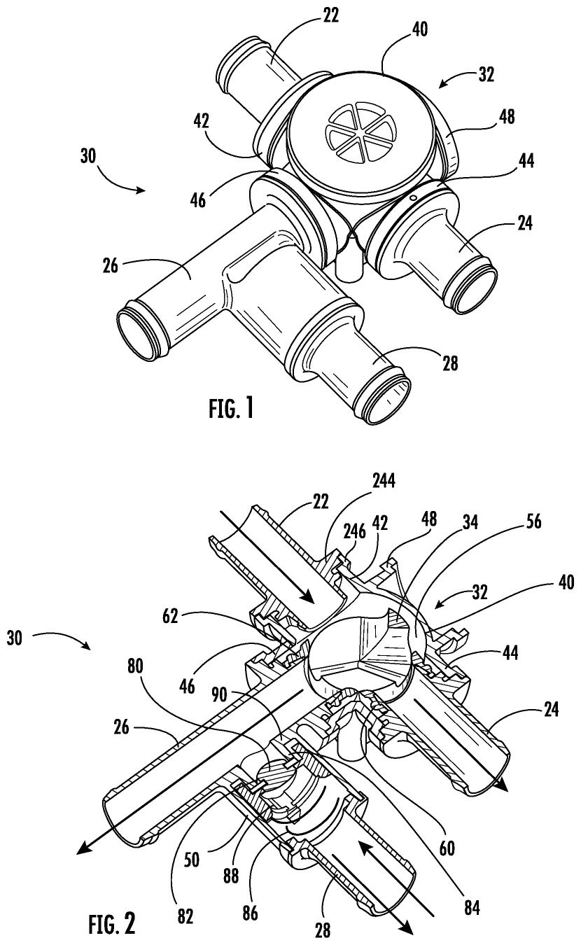

With particular reference now to FIG. 1, an embodiment of a valve assembly 30 according to the invention is illustrated. The valve assembly 30 includes a multi-port valve 32 (also referred to herein as a valve) and an actuator (not shown) mounted to the underside of valve 32 as illustrated in FIG. 1. As will be recognized actuator is responsible for actuating a valve member 34 (see FIG. 2) which in turn governs the flow characteristics through valve 32. The actuator may be any style of actuator typically used in valve actuation, e.g. rotary, linear, etc., and may rely on any type of power source typically used in valve actuation, e.g. electric, hydraulic, pneumatic, etc. As such, the actuator is non-limiting on the invention herein.

Turning now to FIG. 2, valve assembly 30 is shown in a cross-sectional view to expose the componentry thereof, in particular, the componentry of valve 32. Valve 32 includes a housing 40. In one advantageous implementation of the invention, housing 40 is formed as a single piece. By “formed as a single piece” it is meant that the main body of housing 40 and its associated ports are not an assembly of separate components which are subsequently joined together by a joining process, e.g. welding as is done in conventional valve housings. Rather, housing 40 is formed as a single unitary piece by any process capable of achieving such a configuration, e.g. injection molding, 3D printing, etc. However, it is contemplated by the teachings herein that housing 40 may be embodied as an assembly of separate components which are subsequently joined together by a joining process.

Utilizing a one piece housing 40, however, allows for a reduction of parts but a retention of function over prior designs that utilize multicomponent housings. Further, the single piece housing 40 illustrated allows for a single direction of assembly along longitudinal axis defined by housing 40. This is an improvement over prior multi-port valves which typically involve multiple directions of assembly relative to their respective housings.

As illustrated, housing 40 includes a plurality of ports, in particular, a first port 42, a second port 44, a third port 46, and a fourth port 48 (formed in the housing 40 but not utilized in the embodiment illustrated due to the inclusion of housing wall, which may be removed or excluded in embodiments that will utilize the fourth port 48), each of which are in fluid communication with an internal cavity 56 of housing 40. Each of ports 42, 44, 44, 46 may function as an inlet or an outlet of valve 32.

Still referring to FIG. 2, internal cavity 56 receives a valve member 34 which operates as a valve member for controlling the flows between the pluralities of ports 42, 44, 46. At least one seal member, and in the illustrated case two seal members 60, 62, are also received in cavity 56 and entirely surrounds ports 44, 46 used as outlet ports in the embodiment shown. These seal members 60, 62 advantageously create a seal for each of ports 44, 46 to prevent unintended cross flow or short circuiting. Each seal member 60, 62 overlaps an end portion of its associated port body 24, 26 as illustrated such that radial seal, i.e. a seal in the radial direction relative to the longitudinal axes of the seal and its associated port body, is formed between the port body and the seal. As may also be seen in FIG. 2, each seal member 60, 62 and valve member 34 also forms an axial seal, i.e. a seal in the axial direction relative to the longitudinal axes of the seal and its associated port body.

Each seal member 60, 62 is thus associated with each port body 24, 26, respectively. However, it is also envisioned that a single seal member could be utilized that provides the same features and functionality as the two separate seal members 60, 62 as shown. As such, it is contemplated that at least one seal member need only be present to achieve the seal necessary for the functionality of the valve disclosed. Further, it will be recognized from inspection of FIG. 2 that the seal members 60, 62 are arranged such that they do not completely circumscribe valve member 34, thereby reducing the amount of actuation force needed to actuate valve member 34. It will also be recognized from inspection of FIG. 2 that a seal member is not associated with port body 22 given that the same functions as an inlet. Indeed, the individual seals at port bodies 24, 26 are sufficient to prevent flow from bypassing valve member 34 as it flows from port body 22 to either of port bodies 24, 26.

As can be seen from FIG. 2, the valve member 34 includes a plurality of openings. The plurality of openings through valve member 34 are selectively alignable with ports 42, 44, 46 to govern the flows between these ports. In the embodiment illustrated, input flow into port 42 may be selectively provided to output port 44, to output port 46, or to a combination of output port 44 and output port 46, in varying or equal amounts based on the positioning of valve member 34. As may be seen in FIG. 2, ports 42, 44, and 46 are arranged relative to one another such that they are angularly spaced about the center of valve 30 and situated at the same axial height relative to housing 40.

As shown in solid in FIG. 1 and in cross-section in FIG. 2, the valve assembly 30 includes a plurality of port bodies, namely, a first port body 22, a second port body 24, a third port body 26, and a fourth port body 28 (also referred to herein as a check port body 28). Port bodies 22, 24, and 26 are respectively received in the first through third ports 42, 44, and 46 as illustrated. Check port body 28 is received in a check housing 50 (to be discussed more fully below) of port body 26. The port bodies 22 and 24, and the interface of port body 26 to the housing 40 are substantially identical to one another. Accordingly, a description will be provided for the first port body 22 which applies equally well to the remaining port body 24, and the interface for port body 26.

First port body 22 includes a through bore which communicates with an internal cavity 56 containing valve member 34 rotatably disposed therein. A first radially protruding flange 244 extends radially outwardly from first port body 22. This first radially protruding flange 244 abuts an abutment face 246 at first port 42 and is sealed against the same via welding, adhesion, or any other mechanical joining technology. As can be seen in FIG. 2, second and third port bodies 24, 26 bias its respective seal 60, 62 against valve member 34.

As introduced above, port body 26 also includes check housing 50 containing a check valve assembly that allows only one-way flow from port body 26 to check port body 28. This one-way flow or check flow is provided by a check valve member 80 having a sealing member 82 that seals against check valve seat 84 formed in check housing 50. The check valve member 80 is biased by spring 86 acting through bias member 88 that is slidably received in channel 90. The spring bias force may be set or adjusted so that fluid pressure in port body 26 must overcome the spring bias in order to allow flow through the check housing 50 to port body 28.

Once the pressure in port body 26 drops below the spring force, the check valve member will again close. Such controlled checked operation allows for proper sequencing of flows through the various outlets, particularly useful in mixing and separating flow operation. As is shown in the illustrated embodiment, check housing 50 and the check valve assembly contained herein are arranged along a flow axis defined by check port body 28 (i.e. the longitudinal axis of check port body 28) that is transverse to the longitudinal axis of port body 26. In the illustrated embodiment, the flow axis defined by check port body 28 is arranged perpendicular to the longitudinal axis of port body 26, for non-limiting example.

For example, in the embodiment illustrated in FIG. 2, with the valve member 34 positioned as shown, the flow from port body 22 is split between port body 24 and port body 26. With such split flow, the spring force may be set so that there can be no flow through port body 28 until and unless the flow though port body 24 is reduced or completely shut off by proper positioning of valve member 34. This programmed sequencing of flow through the various ports is enabled by this check valve. In other words, the check valve assembly has a closed position wherein flow from port body 26 cannot flow through check port body 28, and an open position wherein flow from port body 26 can flow through check port body 28.

In the closed position, valve member 80 is seated against seat 84, and in the open position, valve member 80 is not seated against seat 84. Transitioning the check valve assembly from the closed position to the open position may be achieved via the redirecting of flow through valve 30 as described above, or can be achieved by simply increasing an input pressure received for example at port body 22 to such an extent that this pressure will overcome the spring force generated by spring 86.

Those skilled in the art will recognize from the foregoing that a check housing assembly such as just described may be integrated into any of the port bodies to provide an additional checked flow therefrom, or to check the flow therethrough.

Housing 40 also includes an aperture (not shown) extending through a bottom wall of housing 40. This aperture is sized to receive a valve stem (not shown) attached to valve member 34. Rotation of this valve stem results in a like rotation of valve member 34 within internal cavity 56. Appropriate seals may be used in conjunction with the valve stem to prevent a leak path along the valve stem and out of housing 40.

In certain embodiments, the port bodies 22, 24, 26, 28 may also include sensors integrated therein, e.g. temperature, pressure, flow sensors, so as to provide monitored parameters for use in controlling the valve.

As described herein, embodiments of the present invention The multi-port valve advantageously overcomes existing problems in the art by presenting an overall construction with a reduced part count, a reduced number of potential leak paths, a reduction in overall assembly time and cost, checked flow, and monitoring of various parameters useful in monitoring and controlling such valve.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A multi-port valve, comprising:
a housing defining an internal cavity, the housing further comprising a plurality of ports, wherein each of the plurality of ports is in communication with the internal cavity;
a valve member rotatably disposed within the internal cavity;
at least one seal member sealingly positioned between the valve member and at least one of the plurality of ports; and
a check valve assembly in fluid communication with at least one of the plurality of ports to provide at least one of an additional checked flow therefrom or a checked flow therethrough.

2. The multi-port valve of claim 1, wherein the plurality of ports includes a first port, a second port, and a third port, the first port, second port, and third ports of the plurality of ports are arranged relative to one another such that they are angularly spaced apart from one another in an angular direction and situated at a same axial height relative to a longitudinal axis of the housing.

3. The multi-port valve of claim 1, further comprising a plurality of port bodies, respectively received in the plurality of ports such that one port body of the plurality of port bodies is received in one port of the plurality of ports.

4. The multi-port valve of claim 3, wherein the at least one seal member includes a plurality of seal members, respectively sealing against one port body of the plurality of port bodies.

5. The multi-port valve of claim 4, wherein each seal member of the plurality of seal members respectively axially overlaps an end portion of each port body such that a radial seal is formed between each seal member and each respective port body.

6. The multi-port valve of claim 5, wherein each seal member of the plurality of seal members axially seals against the valve member.

7. The multi-port valve of claim 3, wherein one port body of the plurality of port bodies includes a check housing extending along axis transverse to a flow axis of the port body.

8. The multi-port valve of claim 7, wherein the check housing contains the check valve assembly.

9. The multi-port valve of claim 8, wherein a check port body is mounted to the check housing and constrains the check valve assembly within the check housing.

10. A multi-port valve, comprising:
a housing defining an internal cavity, the housing further comprising a plurality of ports, wherein each of the plurality of ports is in communication with the internal cavity, wherein a plurality of port bodies are respectively received in the plurality of ports;
a valve member rotatably disposed within the internal cavity;
at least one seal member sealingly positioned between the valve member and at least one of the plurality of ports;
a check valve assembly mounted to one of the plurality of port bodies, the check valve assembly having a closed position wherein fluid flow through the check valve assembly from the port body the check valve assembly is mounted to is prevented, and an open position wherein fluid flow through the check valve assembly from the port body the check valve assembly is mounted to is allowed; and
wherein the check valve assembly is configured to transition from the closed position to the open position upon a transitioning of the valve member such that flow is one of reduced or prevented through another one of the port bodies of the plurality of port bodies.

11. The multi-port valve of claim 10, wherein the plurality of ports includes a first port, a second port, and a third port, the first port, second port, and third ports of the plurality of ports are arranged relative to one another such that they are angularly spaced apart from one another in an angular direction and situated at a same axial height relative to a longitudinal axis of the housing.

12. The multi-port valve of claim 10, wherein the at least one seal member includes a plurality of seal members, respectively sealing against one port body of the plurality of port bodies.

13. The multi-port valve of claim 12, wherein each seal member of the plurality of seal members respectively axially overlaps an end portion of each port body such that a radial seal is formed between each seal member and each respective port body.

14. The multi-port valve of claim 13, wherein each seal member of the plurality of seal members axially seals against the valve member.

15. The multi-port valve of claim 10, wherein one port body of the plurality of port bodies includes a check housing extending along axis transverse to a flow axis of the port body.

16. The multi-port valve of claim 15, wherein the check housing contains the check valve assembly.

17. The multi-port valve of claim 16, wherein a check port body is mounted to the check housing and constrains the check valve assembly within the check housing.

18. A multi-port valve, comprising:
a housing defining an internal cavity, the housing further comprising a plurality of ports, wherein each of the plurality of ports is in communication with the internal cavity, wherein a plurality of port bodies are respectively received in the plurality of ports, wherein one port body of the plurality of port bodies includes a check housing extending along axis transverse to a flow axis of the port body;
a valve member rotatably disposed within the internal cavity;
at least one seal member sealingly positioned between the valve member and at least one of the plurality of ports; and
a check valve assembly mounted within the check housing.

19. The multi-port valve of claim 18, wherein the at least one seal member includes a plurality of seal members, respectively sealing against one port body of the plurality of port bodies.

20. The multi-port valve of claim 19, wherein each seal member of the plurality of seal members respectively axially overlaps an end portion of each port body such that a radial seal is formed between each seal member and each respective port body.
